(19) United States
(12) Patent Application Publication
(10) Pub. No.: US 2026/0015178 A1
(43) Pub. Date: Jan. 15, 2026

(54) WAREHOUSING SYSTEM, WAREHOUSING SCHEDULING METHOD AND WORKSTATION

(71) Applicant: BEIJING GEEKPLUS TECHNOLOGY CO., LTD., Beijing (CN)

(72) Inventor: Yuxing ZHU, Beijing (CN)

(21) Appl. No.: 18/995,462

(22) PCT Filed: Aug. 11, 2023
(86) PCT No.: PCT/CN2023/112607

§ 371 Date: Jan. 16, 2025

(30) Foreign Application Priority Data
Aug. 30, 2022 (CN) 202211048162.3

(51) Int. Cl. B65G 1/137

(52) U.S. Cl. CPC B65G 1/1378; B65G 2209/02; B65G 2209/08; B65G 2209/10

(57) ABSTRACT

A warehousing system includes a plurality of movable carriers, at least one workstation, at least one automatic transport device and a control device. The control device is configured to: acquire a future order; determine a first hit container and a first hit carrier according to the future order; and determine a first hit container to be placed in a temporary storage section as a temporary storage container, and determine a workstation of the warehouse system to receive the temporary storage container as a temporary storage workstation. The automatic transport device is configured to transport at least one first hit carrier storing the temporary storage container to the temporary storage workstation. The temporary storage workstation includes a container handling device, and the container handling device is at least configured to transfer the temporary storage container on the at least one first hit carrier to the temporary storage section.

### CROSS-REFERENCE TO RELATED APPLICATIONS

The present disclosure is a U.S. national stage entry under 35 U.S.C. § 371 of International Application No. PCT/CN2023/112607, filed on Aug. 11, 2023, which claims priority to Chinese Patent Application No. 202211048162.3, filed on Aug. 30, 2022, the entire disclosures of which are hereby incorporated herein by reference.

### FIELD

The present disclosure relates to the field of warehousing devices, and more particularly to a warehousing system, a warehousing scheduling method and a workstation.

### BACKGROUND

In the field of warehousing and logistics, a shelf-to-person picking system has changed the traditional operation mode of finding goods by people. By storing containers in a movable carrier, a carrier transport device transports the movable carrier to a workstation, and the goods are picked by the staff at the workstation or an automatic picking device.

### SUMMARY

Embodiments of the present disclosure provide a warehousing system, a warehousing scheduling method and a workstation.

According to embodiments of a first aspect of the present disclosure, a warehousing system is provided, and includes a plurality of movable carriers, a movable carrier parking area, at least one workstation, at least one automatic transport device and a control device. The control device is coupled to the workstation and the automatic transport device, and the at least one workstation includes a temporary storage workstation. Each movable carrier includes a plurality of storage sections, each storage section is configured to store a container, and the container is configured to store goods. The movable carrier parking area includes a plurality of parking spaces, and each parking space is configured to park the movable carrier. The control device configured to: acquire a future order; determine a first hit container and a first hit carrier according to the future order; and determine a first hit container to be placed in a temporary storage section (for example, a temporary storage section of the workstation) as a temporary storage container, and determine a workstation to receive the temporary storage container in the at least one workstation of the warehouse system as a temporary storage workstation. The first hit container is a container hit by the future order, and the first hit carrier is a movable carrier storing the first hit container. The automatic transport device is configured to transport at least one first hit carrier parked in the movable carrier parking area and storing the temporary storage container to the temporary storage workstation. The temporary storage workstation includes the temporary storage section and a container handling device, the temporary storage section is configured to store the container, and the container handling device is at least configured to transfer at least one temporary storage container on the at least one first hit carrier to the temporary storage section.

According to embodiments of a second aspect of the present disclosure, a warehousing scheduling method is provided, which includes: acquire a future order; determining at least one first hit container and at least one first hit carrier according to the future order, wherein the first hit container is a container hit by the future order, and the first hit carrier is a movable carrier storing the first hit container; determining a temporary storage container from the at least one of the first hit container, and determining a workstation to receive the temporary storage container as a temporary storage workstation; sending a transport instruction to an automatic transport device, so that the automatic transport device transports the at least one first hit carrier parked in a movable carrier parking area and storing the temporary storage container to the temporary storage workstation; and sending a provisional storage instruction to the temporary storage workstation, so that the temporary storage workstation transfers the at least one temporary storage container on the at least one first hit carrier to a temporary storage section of the temporary storage workstation.

According to embodiments of a third aspect of the present disclosure, a workstation is provided, which includes: a temporary storage section configured to store a container, and the container being configured to storing goods; and a container handling device configured to receive a provisional storage instruction, and in response to the provisional storage instruction, transfer at least one temporary storage container on at least one first hit carrier to the temporary storage section, wherein the first hit carrier is a movable carrier storing a first hit container, the first hit container is a container hit by a future order, and the temporary storage container is a first hit container to be placed in the temporary storage section.

### BRIEF DESCRIPTION OF THE DRAWINGS

The following drawings of the present disclosure are incorporated herein as a part of the present disclosure for understanding the present disclosure. Embodiments of the present disclosure and their descriptions are shown in the accompanying drawings to explain the principles of the present disclosure.

FIG. 1 is a schematic view of a warehousing system according to some embodiments of the present disclosure.

FIG. 2 is a schematic view of a workstation in a warehousing system according to some embodiments of the present disclosure.

FIG. 3 is a production work flow chart of a warehousing system according to some embodiments of the present disclosure.

FIG. 4 is an advance temporary storage work flow chart of a warehousing system according to some embodiments of the present disclosure.

FIG. 5 is a flow chart of a warehousing scheduling method according to some embodiments of the present disclosure.

### DETAILED DESCRIPTION

In the following description, numerous specific details are given in order to provide a more thorough understanding of the present disclosure. However, it will be apparent to those skilled in the art that the present disclosure may be practiced without one or more of these details. In other instances, in order to avoid confusion with the present disclosure, some technical features well known in the art have not been described.

In order to thoroughly understand the present disclosure, a detailed description will be set forth in the following. It should be understood that these embodiments are provided so that the present disclosure will be disclosed thoroughly and completely, and will fully convey the concepts of these illustrative embodiments to those skilled in the art. Obviously, the implementation of the embodiments of the present disclosure is not limited to the specific details familiar to those skilled in the art. Preferred embodiments of the present disclosure are described in detail below, however, the present disclosure may have other embodiments besides these detailed descriptions.

Ordinal numbers such as “first” and “second” used in the present disclosure are only signs, and do not have any other meaning, such as a specific order. Moreover, for example, the term “first component” itself does not imply the existence of “second component”, and the term “second component” itself does not imply the existence of “first component”.

It should be noted that the terms “upper”, “lower”, “front”, “left”, “right”, “inner” and “outer” and similar expressions used in the present disclosure are for illustration purposes only, rather than for limitations.

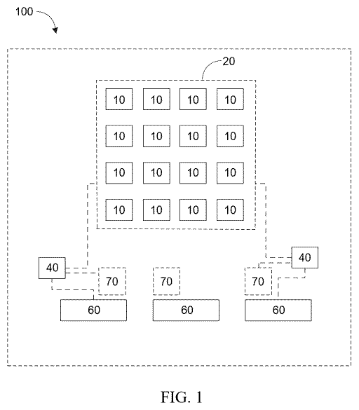

FIG. 1 is a schematic view of a warehousing system according to some embodiments of the present disclosure. As shown in FIG. 1, the warehousing system 100 includes a plurality of movable carriers 10, a movable carrier parking area 20, at least one automatic transport device 40, at least one workstation 60 and a control device (not shown).

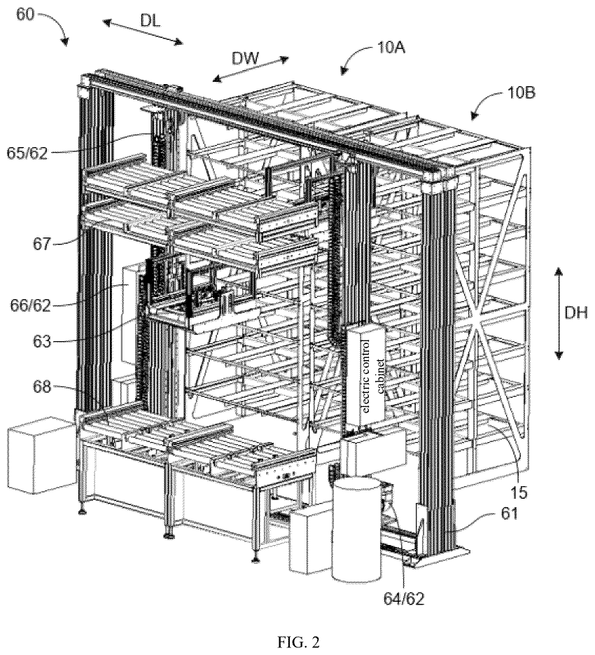

The movable carrier 10 includes a plurality of storage sections 15 for storing containers (as shown in FIG. 2). For example, the storage sections 15 are configured as an accommodation space in a shape of a rectangular parallelepiped, and are arranged in order along a length direction DL, a width direction DW and a height direction DH of the movable carrier 10. The containers are used to store goods. In some embodiments of the present disclosure, the movable carrier 10 may be a shelf, such as a partition shelf, a container shelf, a picking shelf, a movable shelf, and the like. The container may be an accessory product specially designed for the movable carrier 10, or it may be a container such as a goods box, a pallet, etc., which is not limited in the embodiments of the present disclosure.

The movable carrier parking area 20 includes a plurality of parking spaces, and each parking space is used for parking one movable carrier 10. For example, as shown in FIG. 1, the plurality of parking spaces are neatly distributed in rows and columns. The movable carrier parking area 20 may also be referred to as an inventory area.

The workstation 60 includes at least one picking station for picking the containers (for example, taking out articles from the containers or putting articles into the containers). That is, the workstation 60 is used to pick goods according to orders. The workstation 60 is a workstation in a goods picking area, and the workstation 60 may also be called a picking workstation. For example, after the movable carrier 10 is transported to the workstation 60, the container is taken out from the movable carrier 10 manually or by an automatic device at the workstation 60. The automatic device includes an automatic mechanical arm, a container handling device and the like.

The automatic transport device 40 is used to transport the movable carrier 10 between the movable carrier parking area 20 and the workstation 60. The automatic transport device 40 is, for example, a transport robot, which may run to be below the movable carrier 10 and then lift the movable carrier 10 upwards off the ground, so that it may move with holding the movable carrier 10.

The control device is coupled to the workstation 60 and the automatic transport device 40 to control the work of the workstation 60 and the automatic transport device 40. For example, the control device may control the movement of the automatic transport device 40 and control the workstation 60 to pick goods.

In some embodiments, as shown in FIG. 1, the warehousing system 100 further includes a waiting area 70 located closer to the workstation 60 than the movable carrier parking area 20, and the movable carrier 10 may queue up for picking in the waiting area 70. For example, each workstation 60 is configured with a corresponding waiting area 70. The waiting area 70 may be regarded as a part of the workstation 60. The automatic transport device 40 is used to transport the movable carrier 10 among the movable carrier parking area 20, the workstation 60 and the waiting area 70.

FIG. 2 is a schematic diagram of a workstation in a warehouse system according to some embodiments of the present disclosure. As shown in FIG. 2, the workstation 60 includes a plurality of temporary storage sections 67 for placing (temporarily storing or provisionally storing) containers, and a container handling device 63 for at least transferring containers between the temporary storage sections 67 and the movable carrier 10.

For example, as shown in FIG. 2, the workstation 60 further includes a support frame 61 and a picking station 68. The temporary storage section 67 and the container handling device 63 are both arranged to the support frame 61. During logistics production, the automatic transport device 40 transports the movable carrier 10 to a preset working position corresponding to the picking station 68, and the container handling device 63 transports the container required by a production task from the movable carrier 10 to the picking station 68 for picking. After a worker finishes picking, the container handling device 63 puts the container back to the movable carrier 10, and finally the automatic transport device 40 transports the movable carrier 10 back to the movable carrier parking area 20.

In order to enable the container handling device 63 to reach each storage section 15 of the movable carrier 10, the support frame 61 is provided with a guide mechanism 62. The guide mechanism 62 may move transversely and vertically relative to the support frame 61. A transverse direction L corresponds to the length direction DL of the movable carrier 10, and a vertical direction H corresponds to the height direction DH of the movable carrier 10. The container handling device 63 is arranged to the guide mechanism 62, so that the container handling device 63 may move transversely and vertically relative to the support frame 61. The container handling device 63 is coupled to the control device. When the automatic transport device 40 transports the movable carrier 10 to the preset working position relative to the support frame 61 under the control of the control device, the container handling device 63 may reach a position corresponding to the storage section 15 by moving transversely and vertically, so as to take or place the container at the storage section 15. For example, the container handling device 63 has a driving part such as an air cylinder, and thus may move and operate in a direction W (the direction W is perpendicular to the direction L and the direction H, and corresponds to the width direction DW of the movable carrier 10), so as to take out the container at the storage section 15.

In some examples, the guide mechanism 62 includes a transverse movement device 64, a movement rod 65 and a vertical movement device 66. The transverse movement device 64 is arranged to the support frame 61. The transverse movement device 64 is coupled to the control device. The transverse movement device 64 is configured to transversely move relative to the support frame 61. The movement rod 65 extends in the vertical direction. The movement rod 65 is arranged to the transverse movement device 64, so that the movement rod 65 moves transversely relative to the support frame 61 in synchronization with the transverse movement device 64. The vertical movement device 66 is arranged to the movement rod 65. The vertical movement device 66 is coupled to the control device. The vertical movement device 66 is configured to vertically move relative to the movement rod 65. The container handling device 63 is arranged to the vertical movement device 66, so that the container handling device 63 may move vertically relative to the movement rod 65. Therefore, the container handling device 63 may move on the support frame 61 transversely and vertically.

In some embodiments, the workstation 60 may not be provided with the support frame 61, and the container handling device 63 may move horizontally and vertically through the guide mechanism 62. For example, the workstation 60 includes the guide mechanism 62 and the container handling device 63. For example, the guide mechanism 62 is a mechanical arm (also called an automatic mechanical arm), the container handling device 63 may be connected to the mechanical arm, and the container handling device 63 may move transversely or vertically through the mechanical arm (for example, the mechanical arm may move the container handling device 63 transversely or vertically). The mechanical arm may be fixed on the ground or a guide rail, for example, the mechanical arm may be permanently fixed on the ground or the guide rail, or temporarily fixed on the ground or the guide rail, which is not limited in the embodiments of the present disclosure.

Under the action of the guide mechanism 62, the container handling device 63 may transfer the container between different storage sections 15, or between any two of the storage section 15, the temporary storage section 67 and the picking station 68, so that the warehousing system 100 may adjust the storage section of the container on the same movable carrier 10, or move the container among a plurality of movable carriers 10.

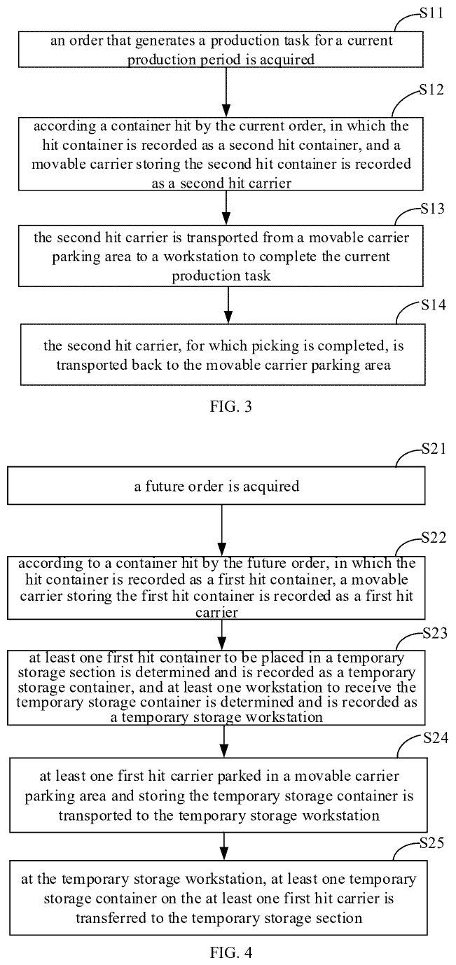

FIG. 3 is a production work flow chart of a warehousing system according to some embodiments of the present disclosure. As shown in FIG. 3, a work flow of the warehousing system 100 to complete a production task may include following steps.

In step S11, an order (also called a current order or a wall-displayed order) that generates a production task for a current production period is acquired.

In step S12, according a container hit by the current order, in which the hit container is recorded as a second hit container, and a movable carrier 10 storing the second hit container is recorded as a second hit carrier.

In step S13, the second hit carrier is transported from a movable carrier parking area 20 to a workstation 60 to complete the production task (i.e., a current production task).

In step S14, the second hit carrier, for which picking is completed, is transported back to the movable carrier parking area 20.

In some embodiments, during the logistics production, if the picking work of a future order may be prepared in advance, the work efficiency of future production may be improved. In order to improve the work efficiency of the future production, the warehousing system 100 may first determine the future order (also known as a wall-undisplayed order), and then implement an advance temporary storage work flow for the future order. The future order includes an estimated order and/or an order used to generate a production task for a next production period.

For example, in an order pool of the warehousing system 100, both the order for generating the production task and the estimated order are included.

The order used to generate the production task refers to an order with a clear production instruction, according to which production may be implemented accurately, such as an order from a customer and an order generated according to needs of logistics work. The content of a minimum stock keeping unit (SKU) of this kind of order is relatively fixed, and the order may be completed by the picking work at the workstation 60. For example, the control device is configured to assign all the received orders for generating the production tasks to the workstation 60 in batches, and the order, which has been assigned to the workstation 60, but for which the picking has not been started or has not been finished, is the wall-displayed order, that is, the order for generating the current production task.

In the present disclosure, the production task refers to picking out all the goods listed in the SKU of the current order from the inventory goods, and concentrating all the goods listed in the SKU of each current order in the same container. Production time refers to a time when the workstation performs the production task. A time when the workstation does not perform the production task is a non-production time.

For example, the estimated order is an order generated by the warehousing system 100 according to the estimation of the future work. For example, the control device is configured to estimate the order according to the historical order and/or the popularity of the goods. The purpose of the warehousing system 100 to estimate the order is to predict and plan a future production task to a certain extent, so that preparations may be made in advance to improve the work efficiency of the future production. In some examples, the estimated order cannot be used to generate the production task, and the content of the SKU of the estimated order may be changed. For example, the estimated order is only valid within a preset time window, and the warehousing system 100 may constantly update the estimated order according to the specific situation. Usually, the updated estimated order will be more consistent with a future task.

In the present disclosure, the future order includes the estimated order and/or an order for generating the production task for the next production period, that are not assigned to the workstation 60.

FIG. 4 is an advance temporary storage work flow chart of a warehousing system according to some embodiments of the present disclosure. As shown in FIG. 4, the warehousing system 100 is configured to complete an advance temporary storage work of following steps in a production time.

In step S21, a future order is acquired.

In step S22, according to a container hit by the future order, in which the hit container is recorded as a first hit container, a movable carrier 10 storing the first hit container is recorded as a first hit carrier.

For example, the first hit container is a container needed for a future production work, which may also be called a pre-hit container.

In some examples, step S22 may also be considered as determining the first hit container and the first hit carrier according to the future order. The first hit container is the container hit by the future order, and the first hit carrier is the movable carrier storing the first hit container.

For example, the first hit container determined according to the future order may include a plurality of containers, which may exist in one movable carrier or be stored in a plurality of movable carriers. The embodiments of the present disclosure do not limit the number of the first hit containers and the number of the first hit carriers.

In step S23, at least one first hit container to be placed in a temporary storage section 67 is determined and is recorded as a temporary storage container, and at least one workstation 60 to receive the temporary storage container is determined and is recorded as a temporary storage workstation.

For example, the above steps S21-S23 may be executed by a control device in the warehousing system 100. That is, the control device may determine the first hit container to be placed in the temporary storage section 67 as the temporary storage container and the workstation 60 to receive the temporary storage container as the temporary storage workstation.

In some examples, step S23 may also be considered as determining the temporary storage container from a plurality of first hit containers. For example, at least one first hit container of the plurality of first hit containers, which is to be placed in the temporary storage section 67, is determined as the temporary storage container.

In step S24, at least one first hit carrier parked in a movable carrier parking area 20 and storing the temporary storage container is transported to the temporary storage workstation.

For example, after determining the temporary storage container and the temporary storage workstation, the control device may send a transport instruction to an automatic transport device 40, and the automatic transport device 40 transports the at least one first hit carrier parked in the movable carrier parking area 20 and storing the temporary storage container to the temporary storage workstation according to the transport instruction.

In step S25, at the temporary storage workstation, at least one temporary storage container on the at least one first hit carrier is transferred to the temporary storage section 67.

For example, step S25 may be performed by a container handling device in the temporary storage workstation. For example, after the automatic transport device 40 transports the at least one first hit carrier storing the temporary storage container to the temporary storage workstation, the control device may send a provisional storage instruction to a container handling device 63 of the temporary storage workstation. The container handling device 63 of the temporary storage workstation transfers the at least one temporary storage container on the at least one first hit carrier to the temporary storage section according to the provisional storage instruction.

Through the advance temporary storage process from step S21 to step S25, the warehousing system 100 places the container needed in the future production in the temporary storage section 67 for temporary storage in advance (that is, placing the goods in the container needed in the future production in the temporary storage section 67 for temporary storage), while performing the current production task, so that in the future production, the container handling device 63 may directly acquire the container from the temporary storage section 67 without acquiring the container from the movable carrier 10. Therefore, the automatic transport device 40 is liberated to a certain extent, and a transport time waiting for the automatic transport device 40 to transport the movable carrier 10 may also be saved, which may improve the production efficiency to a certain extent. The advance temporary storage process is automatically completed by the warehousing system 100, which liberates the manpower and ensures the accuracy of the work.

In step S23, the warehousing system 100 pre-assigns the future order to one or more of the at least one workstation 60, determines the workstation 60 pre-assigned with the future order as the temporary storage workstation, and determines a first hit container bound with the future order pre-assigned to the temporary storage workstation as the temporary storage container.

For example, the warehousing system 100 may include a plurality of workstations 60, and the temporary storage container and the temporary storage workstations establish a corresponding relationship through the future order. For example, the warehousing system 100 includes two workstations 60, namely a workstation A and a workstation B. The future order includes an order C and an order D. The warehousing system 100 pre-assigns the order C to the workstation A and pre-assigns the order D to the workstation B. A container E is a container hit according to the order C, and a container F is a container hit according to the order D. In this case, the workstation A and the container E correspond to each other through the order C, and are the temporary storage workstation and the temporary storage container corresponding to each other; the workstation B and the container F correspond to each other through the order D, and are the temporary storage workstation and the temporary storage container corresponding to each other. There is no order, which is associated with the workstation A and the container F at the same time, between the workstation A and the container F, so that the workstation A and the container F cannot be the temporary storage workstation and the temporary storage container corresponding to each other (the container F has nothing to do with the production task of the workstation A, so that it is meaningless to transport the container F to the workstation A). There is no order, which is associated with the workstation B and the container E at the same time, between the workstation B and the container E, so that the workstation B and the container E cannot be the temporary storage workstation and the temporary storage container corresponding to each other. In the present disclosure, the automatic transport device 40 transports the movable carrier 10 storing the temporary storage container to the temporary storage workstation, which corresponds to the temporary storage container through the future order.

In some embodiments, the same container may be hit by a plurality of future orders at the same time, and the plurality of future orders associated (bound) with the container may be assigned to different workstations 60, so that any workstation 60 that has been pre-assigned with the future order associated with the container may become the temporary storage workstation. In some examples, the control device in the warehousing system is configured to: determine an order index OI of each first hit container on the first hit carrier; determine a correlation index RI of each first hit container on the first hit carrier; and according to the order index OI and the correlation index RI of each first hit container, determine the temporary storage container from the first hit containers on the at least one first hit carrier, and determine the workstation corresponding to the temporary storage container as the temporary storage workstation.

The order index OI is the number of future orders pre-assigned to one workstation, which are hit by the first hit container. The correlation index RI is the number of future orders pre-assigned to one workstation, which are hit by the first hit container and another container in the temporary storage section of the workstation at the same time.

In some examples, the control device is configured to: determine a container index CI of each first hit container relative to a container in each temporary storage section of a workstation according to the order index OI and the correlation index RI of each first hit container; and according to the container index CI of each first hit container relative to the container in each temporary storage section of the workstation, determine the temporary storage container from the first hit containers on the at least one first hit carrier, and determine the workstation corresponding to the temporary storage container as the temporary storage workstation.

For example, in order to improve the utilization rate of the temporary storage container at the temporary storage workstation, the control device is configured to determine the first hit container with the largest container index on the at least one first hit carrier as the temporary storage container, and determine the workstation corresponding to the largest container index as the temporary storage workstation.

The manner in which the warehousing system 100 determines the temporary storage container and the temporary storage workstation will be described in detail below.

For example, the control device is configured to calculate a container index CI of each first hit container on each first hit carrier relative to a container on each temporary storage section 67 of each workstation 60, take the first hit container with the largest container index CI as the temporary storage container, and take the workstation 60 corresponding to the largest container index CI as the temporary storage workstation.

The container index CI is calculated according to the order index OI and the correlation index RI. For example, the container index CI is determined according to a following formula:

$$CI = W 1 \cdot OI + W 2 \cdot RI .$$

W1 and W2 are constants greater than or equal to 0, and W1 and W2 are weight coefficients of the order index OI and the correlation index RI, respectively. Generally, W1 and W2 may be adjusted and set by a user according to specific situations, and the values of W1 and W2 are not limited in the embodiments of the present disclosure.

The order index OI is the number of future orders pre-assigned to one workstation 60, which are hit by one container (for example, one first hit container). The greater the value of the order index OI, the larger the number of the future orders satisfied by the container, so that different orders may be satisfied at the same time, thus improving the work efficiency of the future production.

For example, the warehousing system 100 includes two workstations 60, namely a workstation A and a workstation B. The future order hits two containers, namely a container C and a container D (both the containers C and D are the first hit containers). Twenty two future orders of the future orders pre-assigned to the workstation A hit the container C (that is, the container C hits twenty two future orders of the future orders pre-assigned to the workstation A), and fourteen future orders of the future orders pre-assigned to the workstation A hit the container D (that is, the container D hits fourteen future orders of the future orders pre-assigned to the workstation A). Eighteen further orders of the future orders pre-assigned to the workstation B hit the container C (that is, the container C hits eighteen further orders of the future orders pre-assigned to the workstation B), and ten further orders of the future orders pre-assigned to the workstation B hit the container D (that is, the container D hits ten further orders of the future orders pre-assigned to the workstation B). Then, the order index OICA of the first hit container C with respect to the workstation A is 22, and the order index OICB of the first hit container C with respect to the workstation B is 18. The order index OIDA of the first hit container D with respect to the workstation A is 14, and the order index OIDB of the first hit container D with respect to the workstation B is 10.

The correlation index RI is the number of future orders pre-assigned to one workstation 60, which are hit by one container (for example, one first hit container) and another container in the temporary storage section 67 of the workstation 60 at the same time. The greater the correlation index RI, the higher the degree of aggregation between the container and another container in the temporary storage section 67 at the order level, so that the same future order may be quickly satisfied, thus improving the future production efficiency.

For example, the temporary storage section 67 of the workstation A has containers E and F, and the temporary storage section 67 of the workstation B has containers G and H. The container C and the container E hit one future order of the future orders pre-assigned to the workstation A at the same time. The container C and the container F hit two future orders of the future orders pre-assigned to the workstation A at the same time. The container C and the container G hit three future orders of the future orders pre-assigned to the workstation B at the same time. The container C and the container H hit four future orders of the future orders pre-assigned to the workstation B at the same time. The container D and the container E hit five future orders of the future orders pre-assigned to the workstation A at the same time. The container D and the container F hit six future orders of the future orders pre-assigned to the workstation A at the same time. The container D and the container G hit seven future orders of the future orders pre-assigned to the workstation B at the same time. The container D and the container H hit 8 future orders of the future orders pre-assigned to the workstation B at the same time. Then, the correlation index RICE of the container C with respect to the container E is 1, the correlation index RICF of the container C with respect to the container F is 2, the correlation index RICG of the container C with respect to the container G is 3, and the correlation index RICH of the container C with respect to the container H is 4. The correlation index RIDE of the container D with respect to the container E is 5, the correlation index RIDF of the container D with respect to the container F is 6, the correlation index RIDG of the container D with respect to the container G is 7, and the correlation index RIDH of the container D with respect to the container H is 8. It may be understood that when there is no container in the temporary storage section 67, the correlation index RI is 0, and the container index CI is only related to the order index. It may be understood that when the order index OI of a container relative to a workstation 60 is 0, it means that all the future orders pre-assigned to the workstation 60 have nothing to do with the container, so it is impossible for the container to hit the future orders pre-assigned to the workstation 60 at the same time with any container in the temporary storage section 67 of the workstation 60, that is, the correlation index RI of the container is 0.

For example, in a case that W1=W2=1,
the container index CICE of the container C relative to the container E in the temporary storage section 67 of the workstation A is denoted as CICE=OICA+RICE=22+1=23;
the container index CICF of the container C relative to the container F in the temporary storage section 67 of the workstation A is denoted as CICF=OICA+RICF=22+2=24;
the container index CICG of the container C relative to the container G in the temporary storage section 67 of the workstation B is denoted as CICG=OICB+RICG=18+3=21;
the container index CICH of the container C relative to the container H in the temporary storage section 67 of the workstation B is denoted as CICH=OICB+RICH=18+4=22;
the container index CIDE of the container D relative to the container E in the temporary storage section 67 of the workstation A is denoted as CIDE=OIDA+RIDE=14+5=19;
the container index CIDF of the container D relative to the container F in the temporary storage section 67 of the workstation A is denoted as CIDF=OIDA+RIDF=14+6=20;
the container index CIDG of the container D relative to the container G in the temporary storage section 67 of the workstation B is denoted as CIDG=OIDB+RIDG=10+7=17; and
the container index CIDH of the container D relative to the container H in the temporary storage section 67 of the workstation B is denoted as CIDH=OIDB+RIDH=10+8=18.

The container index CICF of the container C relative to the container F in the temporary storage section 67 of the workstation A is the largest, so that the first hit container C is used as the temporary storage container and the workstation A is used as the temporary storage workstation. The container index CI comprehensively considers the binding relationship between the container and the workstation, as well as the correlation relationship between the containers. Determining the temporary storage container and the temporary storage workstation by the container index CI may maximize the contribution of the temporary storage container to the temporary storage workstation, that is, improving the utilization rate of the temporary storage container in the temporary storage workstation, which may improve the production efficiency to a certain extent. As mentioned above, the future order has not been assigned to the workstation 60, so that the warehousing system 100 may adjust the strategy of assigning the future order to the workstation 60, thereby improving the utilization rate of the first hit container at the workstation 60. For example, the warehousing system 100 may centrally pre-assign future orders bound to the same first hit container to the workstation 60, for example, to the same workstation 60. In this way, the utilization rate of the first hit container in the workstation may be maximized.

It may be understood that since the part of the estimated order in the future orders is variable, with the change of the estimated order, the first hit container, the first hit carrier and the container index CI of the first hit container are all variable.

In some embodiments, the first hit container includes a container storing first hit goods and/or a container storing goods associated with first hit goods. The first hit goods are the goods included in the SKU of the future order. For example, the control device is configured to determine the goods associated with the first hit goods according to the historical order. For example, the SKU of the future order contains goods A (such as a basketball), and goods B (such as an inflator) are goods associated with the goods A (for example, according to the historical sales situation, merchants usually provide the inflator for free when selling the basketball). Therefore, any container in which the goods A are stored and/or any container in which the goods B are stored are the first hit containers.

In this way, the warehousing system 100 gives more comprehensive consideration to the future production task and prepares for the future production task in advance, which is beneficial to improving the future production efficiency.

In some embodiments, the warehousing system 100 hits the first hit container according to the future order, and hits the second hit container according to the current order. The first hit container and the second hit container may be placed in the same movable carrier 10 at the same time, that is, the movable carrier 10 may be both the first hit carrier and the second hit carrier at the same time. For example, when the movable carrier 10 is both the first hit carrier and the second hit carrier at the same time, and the movable carrier 10 is located at the workstation 60, the container handling device 63 may also transfer the first hit container in the movable carrier 10 to the temporary storage section 67. That is, the warehousing system 100 prepares for the next production task while completing the current production task.

For example, when the container handling device 63 transfers the first hit container in the movable carrier 10 to the temporary storage section 67, in order to further improve the future production efficiency, the control device is configured to calculate the container index CI of each first hit container in the movable carrier 10 with respect to the container in each temporary storage section 67 of the workstation 60 that completes the current production task (that is, with respect to the current workstation 60 associated with the second hit carrier), and to control the container handling device 63 to transfer the first hit container with the largest container index CI to the temporary storage section 67. The calculation method of the container index CI refers to the previous description, and will not be repeated here.

In some embodiments, in order to meet various requirements in the warehousing system (such as production needs, tally needs, etc.), the automatic transport device 40 may transport the movable carrier 10 between places. If the warehousing system 100 is equipped with a limited number of automatic transport devices 40, the total capacity of the limited number of automatic transport devices 40 is limited, and the capacity of the automatic transport devices 40 gives priority to meeting the needs of the current production task. The automatic transport device 40 is configured such that when the capacity of the automatic transport device 40 is still available on the premise of transporting the second hit carrier to complete the current production task, the automatic transport device 40 may transport at least one movable carrier 10, that is only the first hit carrier but not the second hit carrier, to the temporary storage workstation.

For example, the warehousing system 100 calculates the container index CI of each first hit container on each movable carrier 10, that is only the first hit carrier but not the second hit carrier, with respect to the container in each temporary storage section 67 of each workstation, takes the first hit container with the largest container index CI as the temporary storage container, and the workstation 60 corresponding to the largest container index CI as the temporary storage workstation. The calculation method of the container index CI refers to the above description, and will not be described here.

In some embodiments, the requirements of the production task for the capacity of the automatic transport device 40 include transporting the second hit carrier to the workstation 60, transporting the second hit carrier to the waiting area 70, transporting the second hit carrier in the waiting area 70 to the workstation 60 and transporting the second hit carrier, for which picking has been completed at the workstation 60, away from the workstation 60. That is, the requirement of the production task for the capacity of the automatic transport device 40 mainly includes transporting the second hit carrier associated with the current production task (or the current order). When the automatic transport device 40 has met the transport requirements of the production task, or when there is no second hit carrier to be transported, the automatic transport device 40 has an idle capacity. For example, all the second hit carriers have been transported to the workstation 60 or the waiting area 70, and each workstation 60 has the second hit carrier to be picked, so that the automatic transport device 40 has a remaining part for a period of time before the workstation 60 finishes picking the current second hit carrier.

For example, the workstation 60 may move the container between a plurality of movable carriers 10. As shown in FIG. 2, two movable carriers 10A and 10B are simultaneously located at the preset working position corresponding to the picking station 68 to complete the production task. For example, this production task requires that a container A located on the movable carrier 10A and a container B located on the movable carrier 10B be exchanged. In a case that the movable carrier 10A and the movable carrier 10B have no vacant storage sections 15, the warehousing system 100 may first place one of the containers A and B in the temporary storage section 67, so that the movable carrier 10A or the movable carrier 10B may vacate a vacant storage section 15, so as to exchange the container A on the movable carrier 10A with the container B located on the movable carrier 10B.

In order not to affect the production task, when each workstation 60 includes a plurality of temporary storage sections 67, for example, the control device is configured such that the number of vacant temporary storage sections 67 of each workstation 60 is not less than a preset number, and the preset number is less than the total number of temporary storage sections 67. That is, the warehousing system 100 always keeps at least a preset number of vacant temporary storage sections 67 in each workstation 60. In some examples, the preset number is 1, and the embodiments of the present disclosure do not limit the value of the preset number.

In some embodiments, the container index of the first hit container may change because the estimated order may be continuously updated. That is, the first hit container previously placed in the temporary storage section 67 according to the principle of the maximum container index may be no longer the container with the largest container index. In other words, with the update of the estimated order, the contribution of the container to the future production task will change. The worth of the container that is previously thought to contribute a lot may decrease, while the worth of the container that is previously thought to contribute a little may increase. Therefore, the warehousing system 100 may also update the first hit container, which has been placed in the temporary storage section 67, in time.

In some examples, during the update of the estimated order, when the number of vacant temporary storage sections 67 of a workstation 60 is equal to the preset number, the warehousing system 100 respectively calculates the container index CI of each first hit container on the first hit carrier with respect to the container in each temporary storage section 67 of each workstation 60, and the container index CI of each container in the temporary storage section 67 of the workstation 60 with respect to the container in each of other temporary storage sections 67 of the workstation 60. If the container index CI of the first hit container on the first hit carrier is greater than the container index CI of the container in the temporary storage section 67, the first hit container on the first hit carrier is exchanged with the container in the temporary storage section 67. By placing the first hit container with a large container index CI in the temporary storage section 67, the present disclosure may ensure that the container in the temporary storage section is always a container that contributes greatly to the future production task, so as to improve the production efficiency of the future work. The calculation method of the container index CI refers to the above description, and will not be described here.

It may be understood that if the number of vacant temporary storage sections 67 of a workstation 60 is equal to the preset number, the warehousing system 100 may determine the first hit container, that has a great contribution to the production task of a future workstation, according to the container index CI, and then directly place the first hit container in the temporary storage section 67.

In some embodiments, when the estimated order is updated, the first hit container which is hit previously may become not a first hit container, that is, the container is hit by a future order before the update, but not by a future order after the update. In order to improve the efficiency of the future work, the workstation 60 may remove the container, which is no long the first hit container, in the temporary storage section 67 in time, so as to vacate the temporary storage section 67 for placing the first hit container. For example, in the process of updating the container placed in the temporary storage section 67, when there is a vacant storage section 15 on the movable carrier 10 located at the workstation 60, the workstation 60 is also configured to place the container, that is no longer the first hit container, in the temporary storage section 67 of the workstation 60 into the vacant storage section on the movable carrier 10 located at the workstation 60.

In the warehousing system 100 provided by the embodiment of the present disclosure, the container hit by the future order (such as a pre-hit container) is placed in the workstation for temperate storage in the current production period, and the future production work is prepared in advance, so that when the future production task is performed, it is unnecessary to transport the container from the storage area to the workstation, and the production efficiency of the future work may be improved. Moreover, the warehousing system 100 comprehensively considers the binding relationship between the future order and the pre-hit container, as well as the binding relationship between the future order and the workstation 60, so as to determine the binding relationship between the pre-hit container and the workstation. In addition, the warehousing system 100 may also consider the condition of the temporary storage section 67 of each workstation 60 as a whole, such as the number of available temporary storage sections 67 and the contribution of the container already in the temporary storage section 67 to the future production work. When the workstation 60 has the available temporary storage section 67, the warehousing system 100 transfers the pre-hit container to the temporary storage section 67. When the pre-hit container on the movable carrier 10 contributes more to the future production than the container already in the temporary storage section 67, the warehousing system 100 exchanges the two containers, that is, replacing the container having a small contribution in the temporary storage section 67 with the pre-hit container having a large contribution, so as to ensure that the container in the temporary storage section 67 always is the container that contributes greatly to the future production task, thus improving the production efficiency of the future work.

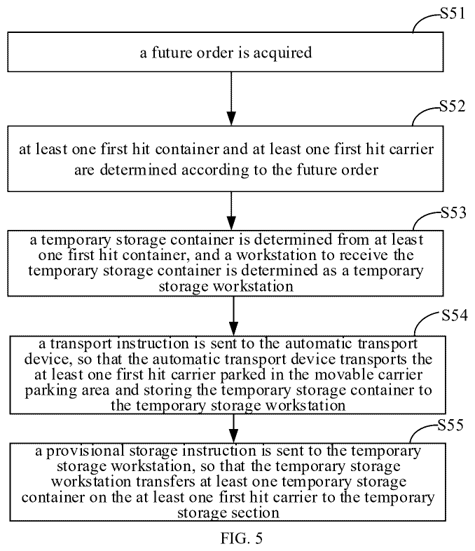

FIG. 5 is a flow chart of a warehouse scheduling method provided by an embodiment of the present disclosure, which may be performed by a control device. As shown in FIG. 5, the method includes following steps.

In step S51, a future order is acquired.

For example, the control device may estimate the future order according to the historical order and/or the popularity of goods.

In step S52, at least one first hit container and at least one first hit carrier are determined according to the future order.

The first hit container is a container hit by the future order, and the first hit carrier is a movable carrier storing the first hit container.

In step S53, a temporary storage container is determined from at least one first hit container, and a workstation to receive the temporary storage container is determined as a temporary storage workstation.

For example, step S53 includes determining an order index of each first hit container; determining a correlation index of each first hit container; and according to the order index and the correlation index of each first hit container, determining the temporary storage container from the at least one first hit container, and determining the workstation corresponding to the temporary storage container as the temporary storage workstation.

The order index is the number of future orders pre-assigned to one workstation, which are hit by the first hit container. The correlation index is the number of future orders pre-assigned to one workstation, which are hit by the first hit container and another container in the temporary storage section of the workstation at the same time.

For example, the control device may determine a container index CI of each first hit container with respect to the container in each temporary storage section of the workstation according to the order index OI and the correlation index RI of each first hit container. According to the container index CI of each first hit container with respect to the container in each temporary storage section of the workstation, the temporary storage container is determined from the first hit containers on the at least one first hit carrier, and the workstation corresponding to the temporary storage container is determined as the temporary storage workstation.

In some examples, the container index is obtained by a following formula:

$$CI = W 1 \cdot OI + W 2 \cdot RI .$$

OI is the order index, RI is the correlation index, W1 and W2 are weight coefficients of the order index OI and the correlation index RI, respectively, and W1 and W2 are constants greater than or equal to 0.

For example, in order to improve the utilization rate of the temporary storage container in temporary storage workstation, the control device may determine the first hit container with the largest container index on the at least one first hit carrier as the temporary storage container, and determine the workstation corresponding to the largest container index as the temporary storage workstation.

In step S54, a transport instruction is sent to the automatic transport device, so that the automatic transport device transports the at least one first hit carrier parked in the movable carrier parking area and storing the temporary storage container to the temporary storage workstation.

In step S55, a provisional storage instruction is sent to the temporary storage workstation, so that the temporary storage workstation transfers at least one temporary storage container on the at least one first hit carrier to the temporary storage section.

In some embodiments, if the second hit carrier storing the second hit container hit by the current production task includes the first hit container, the control device may also instruct the temporary storage workstation to transfer the first hit container on the second hit carrier to the temporary storage section. That is, when the picking work of the current production task is completed, if it is found that there a container needed for the future production on the movable carrier, the container needed for the future production may be placed in the workstation for temporary storage. Therefore, there is no need for the automatic transport device to pay an extra capacity to transport the movable carrier carrying the container needed for the future production, thus liberating the capacity of the automatic transport device to a certain extent.

According to the warehousing scheduling method provided by the embodiment of the present disclosure, by planning the future order for the future work, the container needed for the future order task is placed in the workstation in advance for advance temporary storage in the current production period. Therefore, when carrying out the future production task, since the container has been placed in the workstation, it is not necessary to acquire the container from the storage area, which saves the time for transporting the container from the storage area to the workstation, thus improving the working efficiency of the future production.

The flows and steps described in all the above embodiments are only examples. Unless adverse effects occur, various processing operations may be carried out in a different order from the above flow. The sequence of steps in the above flow may also be added, merged or deleted according to actual needs.

The flows and steps described in all the above embodiments are only examples. Unless adverse effects occur, various processing operations may be carried out in a different order from the above flow. The sequence of steps in the above flow may also be added, merged or deleted according to actual needs.

When understanding the scope of the present disclosure, the term “comprise” and its derivatives as used herein are intended to be open-ended terms that specify the existence of recited features, elements, components, groups, integers and/or steps, but do not exclude the existence of other unrecorded features, elements, components, groups, integers and/or steps. This concept also applies to words with similar meanings, such as the terms “include” and “have” and their derivatives.

The term “attached” or “attach” as used herein includes a configuration in which an element is directly fixed to another element by directly fixing the element to another element; a configuration in which an element is fixed to an intermediate member which in turn is fixed to another element so that the element is indirectly fixed to another element; and a configuration in which an element is integrated with another element, that is, the element is substantively a part of another element. This definition also applies to words with similar meanings, such as “connect”, “join”, “couple”, “mount”, “adhere”, “fix” and their derivatives. Finally, degree terms such as “substantially”, “about” and “approximately” used herein indicate that the terms are modified so that the final result does not change with a significant amount of deviation.

Unless otherwise defined, technical and scientific terms used herein have the same meaning as commonly understood by those skilled in the field of the present disclosure. The terms used herein are only for the purpose of describing specific implementations and are not intended to limit the present disclosure. A feature described in an embodiment herein may be applied to another embodiment alone or in combination with other features, unless the feature is not applicable in the other embodiment or otherwise specified.

The present disclosure has been explained by the above embodiments, but it should be understood that the above embodiments are only for the purpose of illustration and description, and are not intended to limit the present disclosure to the described embodiments. In addition, it may be understood by those skilled in the art that the present disclosure is not limited to the above embodiments, and more variations and modifications may be made according to the teaching of the present disclosure, which fall within the scope of the protection of the present disclosure.

1. A warehousing system, comprising:
a plurality of movable carriers, wherein each movable carrier comprises a plurality of storage sections, each storage section is configured to store a container, and the container is configured to store goods;
a movable carrier parking area comprising a plurality of parking spaces, and each parking space being configured to park each movable carrier;
a control device configured to:
acquire a future order;
determine a first hit container and a first hit carrier according to the future order; and
determine a first hit container to be placed in a temporary storage section as a temporary storage container, and determine a workstation of the warehousing system to receive the temporary storage container as a temporary storage workstation,
wherein the first hit container is a container hit by the future order, and the first hit carrier is a movable carrier storing the first hit container;
at least one automatic transport device coupled to the control device, and configured to transport at least one first hit carrier parked in the movable carrier parking area and storing the temporary storage container to the temporary storage workstation; and
at least one workstation coupled to the control device, and comprising the temporary storage workstation, and the temporary storage workstation comprising the temporary storage section and a container handling device, wherein the temporary storage section is configured to store the container, and the container handling device is at least configured to transfer at least one temporary storage container on the at least one first hit carrier to the temporary storage section.

2. The warehousing system according to claim 1, wherein the future order comprises at least one of: an order for generating a production task for a next production period, and an estimated order; and
the control device is configured to perform at least one of following actions:
assigning all received orders for generating the production task to the at least one workstation in batches; and
estimating an order according to at least one of a historical order and a popularity of the goods.

3. (canceled)

4. The warehousing system according to claim 1, wherein the control device is configured to:
pre-assign the future order to one or more of the at least one workstation;
determine the one or more of the at least one workstation to which the future order is pre-assigned as the temporary storage workstation; and
determine a first hit container bound with the future order of the temporary storage workstation as the temporary storage container.

5. (canceled)

6. The warehousing system according to claim 4, wherein the control device is configured to:
determine an order index of each first hit container on the first hit carrier, wherein the order index is a number of future orders pre-assigned to one workstation, which are hit by the first hit container;
determine a correlation index of each first hit container on the first hit carrier, wherein the correlation index is a number of future orders pre-assigned to one workstation, which are hit by the first hit container and another container in the temporary storage section of the workstation at the same time; and
according to the order index and the correlation index of each first hit container, determine the temporary storage container from the first hit containers on the at least one first hit carrier, and determine a workstation corresponding to the temporary storage container as the temporary storage workstation.

7. The warehousing system according to claim 6, wherein the control device is configured to:
determine a container index of each first hit container with respect to a container in each temporary storage section of the workstation according to the order index and the correlation index of each first hit container; and
determine the temporary storage container from the first hit containers on the at least one first hit carrier according to the container index of each first hit container with respect to the container in each temporary storage section of the workstation, and determine the workstation corresponding to the temporary storage container as the temporary storage workstation.

8. The warehousing system according to claim 7, wherein the control device is configured to:
determine a first hit container with a largest container index on the at least one first hit carrier as the temporary storage container, and determine a workstation corresponding to the largest container index as the temporary storage workstation.

9. The warehousing system according to claim 4, wherein the control device is configured to:
calculate a container index (CI) of each first hit container on the first hit carrier with respect to a container in each temporary storage section of the workstation, wherein CI=W1·OI+W2·RI, OI is a number of future orders pre-assigned to the workstation, which are hit by the first hit container, RI is a number of future orders pre-assigned to the workstation, which are hit by the first hit container and another container in the temporary storage section of the workstation at the same time, and W1 and W2 are constants greater than or equal to 0; and
determine a first hit container with a largest container index on the at least one first hit carrier as the temporary storage container, and determine a workstation corresponding to the largest container index as the temporary storage workstation.

10. The warehousing system according to claim 4, wherein in a current production period, the control device is further configured to:
hit a container according to a current production task, wherein the container hit by the current production task is a second hit container, and a movable carrier storing the second hit container is a second hit carrier;
transport the second hit carrier to the workstation to complete the current production task; and
transfer the first hit container on the second hit carrier to the temporary storage section.

11. The warehousing system according to claim 10, wherein the control device is configured to:
calculate a container index (CI) of each first hit container on the second hit carrier with respect to a container in each temporary storage section of a current workstation associated with the second hit carrier; and
transfer a first hit container with a largest container index to the temporary storage section,
wherein CI=W1·OI+W2·RI, OI is a number of future orders pre-assigned to the workstation, which are hit by the first hit container, RI is a number of future orders pre-assigned to the workstation, which are hit by the first hit container and another container in the temporary storage section of the workstation at the same time, and W1 and W2 are constants greater than or equal to 0.

12. The warehousing system according to claim 10, wherein in the current production period, the at least one automatic transport device is configured to transport at least one movable carrier, which is only the first hit carrier but not the second hit carrier, to the temporary storage workstation, when a capacity of the at least one automatic transport device still has a remaining part on a premise of transporting the second hit carrier to complete the current production task.

13. The warehousing system according to claim 12, wherein the warehousing system comprises a plurality of workstations, and the control device is configured to:
calculate a container index (CI) of the first hit container on the movable carrier, which is only the first hit carrier but not the second hit carrier, with respect to a container in each temporary storage section of the workstation, wherein CI=W1·OI+W2·RI, OI is a number of future orders pre-assigned to the workstation, which are hit by the first hit container, RI is a number of future orders pre-assigned to the workstation, which are hit by the first hit container and another container in the temporary storage section of the workstation at the same time, and W1 and W2 are constants greater than or equal to 0; and
determine a first hit container with a largest container index as the temporary storage container, and determine a workstation corresponding to the largest container index as the temporary storage workstation.

14. The warehousing system according to claim 4, wherein the workstation comprises a plurality of temporary storage sections, and the control device is configured such that number of vacant temporary storage sections is not less than a preset number, wherein the preset number is less than a total number of the plurality of temporary storage sections.

15. The warehousing system according to claim 14, wherein the control device is configured to:
when the number of vacant temporary storage sections is equal to the preset number, calculate a container index (CI) of each first hit container on the first hit carrier with respect to a container in each temporary storage section of the workstation, and a container index (CI) of the container in the temporary storage section with respect to containers in other temporary storage sections of the workstation; and
when the container index of the first hit container is greater than the container index of the container in the temporary storage section, exchange the first hit container having a larger container index with the container having a smaller container index in the temporary storage section,
where CI=W1·OI+W2·RI, OI is a number of future orders pre-assigned to the workstation, which are hit by the container, RI is a number of future orders pre-assigned to the workstation, which are hit by the container and another container in the temporary storage section of the workstation at the same time, and W1 and W2 are constants greater than or equal to 0.

16. (canceled)

17. (canceled)

18. The warehousing system according to claim 1, wherein the workstation further comprises a support frame and at least one guide mechanism, and the container handling device is configured to move transversely and vertically through the at least one guide mechanism; and
the at least one guide mechanism includes:
a transverse movement device arranged to the support frame, coupled to the control device, and configured to move transversely relative to the support frame;
a movement rod extending in a vertical direction, and arranged to the transverse movement device so that the movement rod is configured to move transversely relative to the support frame; and
a vertical movement device arranged to the movement rod, coupled to the control device, and configured to move vertically relative to the movement rod,
wherein the container handling device is arranged to the vertical movement device.

19. A warehousing scheduling method, comprising:
acquire a future order;
determining at least one first hit container and at least one first hit carrier according to the future order, wherein each first hit container is a container hit by the future order, and each first hit carrier is a movable carrier storing one first hit container;
determining a temporary storage container from the at least one first hit container, and determining a workstation to receive the temporary storage container as a temporary storage workstation;
sending a transport instruction to an automatic transport device, so that the automatic transport device transports the at least one first hit carrier parked in a movable carrier parking area and storing the temporary storage container to the temporary storage workstation; and
sending a provisional storage instruction to the temporary storage workstation, so that the temporary storage workstation transfers the temporary storage container on the at least one first hit carrier to a temporary storage section of the temporary storage workstation.

20. The warehousing scheduling method according to claim 19, wherein determining the temporary storage container from the at least one first hit container and determining the workstation to receive the temporary storage container as the temporary storage workstation comprises:
determining an order index of each first hit container, wherein the order index is a number of future orders pre-assigned to one workstation, which are hit by the first hit container;
determining a correlation index of each first hit container, wherein the correlation index is a number of future orders pre-assigned to one workstation, which are hit by the first hit container and another container in the temporary storage section of the workstation at the same time; and
determining the temporary storage container from the at least one first hit container according to the order index and the correlation index of each first hit container, and determining a workstation corresponding to the temporary storage container as the temporary storage workstation.

21. The warehousing scheduling method according to claim 20, wherein determining the temporary storage container from the at least one first hit container according to the order index and the correlation index of each first hit container, and determining the workstation corresponding to the temporary storage container as the temporary storage workstation comprises:
determining a container index of each first hit container with respect to a container in each temporary storage section of the workstation according to the order index and the correlation index of each first hit container; and
determining the temporary storage container from the first hit containers on the at least one first hit carrier according to the container index of each first hit container with respect to the container in each temporary storage section of the workstation, and determining the workstation corresponding to the temporary storage container as the temporary storage workstation.

22. The warehousing scheduling method according to claim 21, wherein the container index is obtained by a following formula:
$$CI = W 1 \cdot OI + W 2 \cdot RI ,$$
wherein OI is the order index, RI is the correlation index, W1 and W2 are weight coefficients of the order index and the correlation index, respectively, and W1 and W2 are constants greater than or equal to 0.

23. The warehousing scheduling method according to claim 21, wherein determining the temporary storage container from the first hit containers on the at least one first hit carrier according to the container index of each first hit container with respect to the container in each temporary storage section of the workstation, and determining the workstation corresponding to the temporary storage container as the temporary storage workstation, comprises:
determining a first hit container with a largest container index on the at least one first hit carrier as the temporary storage container, and determining a workstation corresponding to the largest container index as the temporary storage workstation.

24. A workstation, comprising:
a temporary storage section configured to store a container, and the container being configured to storing goods; and
a container handling device configured to receive a provisional storage instruction, and in response to the provisional storage instruction, transfer at least one temporary storage container on at least one first hit carrier to the temporary storage section, wherein each first hit carrier is a movable carrier storing a first hit container, each first hit container is a container hit by a future order, and each temporary storage container is a first hit container to be placed in the temporary storage section.

25. (canceled)

26. (canceled)
